(19) United States
(12) Patent Application Publication
(10) Pub. No.: US 2007/0205625 A1
(43) Pub. Date: Sep. 6, 2007

(54) Motor Vehicle Comprising An Input Device

(76) Inventors: Jackie Lai, Mountain View, CA (US); Philippe Alessandrini, Cambridge, MA (US); Brian Ng, San Jose, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/617,886

(22) Filed: Dec. 29, 2006

Related U.S. Application Data
(60) Provisional application No. 60/754,993, filed on Dec. 29, 2005.

(51) Int. Cl. B60R 27/00

(52) U.S. Cl. 296/70; 296/24.34

(57) ABSTRACT

The invention relates to a motor vehicle, said motor vehicle comprising a soft fabric arranged in a passenger compartment of the motor vehicle for emitting an output signal depending on pressure exerted on the soft fabric, wherein at least one electrical property of the soft fabric can be changed as a function of the pressure exerted on the soft fabric, and wherein the motor vehicle comprises a control unit for evaluating the output signal for the purpose of a text recognition.

### CROSS-REFERENCE TO RELATED APPLICATIONS

This application claims the benefit of U.S. Provisional Application No. 60/754,993 filed on Dec. 29, 2005, entitled “KRAFTFAHRZEUG MIT EINER EINGABEVORRICHTUNG”, which is incorporated herein in its entirety.

### TECHNICAL FIELD

The invention relates to a motor vehicle comprising an input device.

### BACKGROUND

In order to achieve an easy operation of motor vehicles, it is known, for example, to illuminate input devices, so that the user can recognize them more easily. Thus DE 299 12 656 U1, for example, discloses a functional element, which can be illuminated and which comprises keys designed as at least partly translucent and/or reflecting domes. The domes are designed such that they can be illuminated almost completely by means for illuminating the keys. The means for illuminating the keys are further connected to a carrier board. The means for illuminating the keys are fixed on the side of the carrier board, said side being located opposite to the side on which the keys are attached. Furthermore, the means for illuminating the keys are accommodated in a housing. For improving the haptic properties of the keys, the domes can be produced from transparent polyurethane. For producing the necessary switching operation, the carrier material is equipped with contact springs, which, when pressed down, perform the electrical function of normally open contacts. Provision has been further made to design the carrier material to be translucent or recessed in the region of the means for illuminating the keys.

A functional element, which can be illuminated, is further known from DE 44 25 577 C2. Thus DE 44 25 577 C2 discloses a switch cover for an illuminated switch in a motor vehicle, wherein the switch cover is designed to be transparent and is held on a casing of the switch and a film disposed behind the switch cover has a printed surface on its side turned towards the switch cover, wherein the printed surface has a small degree of reflection, the non-printed surfaces of the film having a high degree of reflection and light emitted from a light source disposed in the casing is introduced laterally into the switch cover so that it substantially does not escape and is reflected only on the non-printed surfaces in such a way that it escapes from the switch cover. Provision is further made to spray the switch cover on the film provided with the printed surface.

Furthermore, a touch screen disposed above a display can be used as an input device in a motor vehicle. A touch screen is known, e.g., from DE 201 02 197 U1. DE 201 02 197 U1 discloses a touch screen for visually representing electronic signals and for inputting signs and symbols by touching the screen for confirmation purposes. It includes a functional plane for visual representation and keystroke input and a higher-level protective plane corresponding thereto that is deformable at certain points. When certain points of the functional plane are selected by touching-type contact across the protective plane, at least one confirmation signal is generated for the user's sense of touch (haptic stimulus) that is perceptible at the position of the point of contact in the deformed protective plane, and the confirmation signal for the sense of touch (haptic stimulus) is generated by vibration elements eccentrically positioned within and/or underneath the functional plane. In addition, in the touch screen known from DE 201 02 197 U1, the generated vibrations are transmitted from the functional plane to the protective plane as the result of direct contacting of the two planes and/or via the edge regions of the planes by way of rigid or elastic connection elements. In addition, touch screens are known, e.g. from U.S. Pat. No. 4,885,565 and EP 920 704 B1. Touch screens can be obtained e.g. from 3M™ (see www.3m.com). Further details concerning touch screens may be gathered e.g. from EP 1 560 102 A1.

DE 10 2004 035 444 describes an operating element for a vehicle for operating a function of the vehicle by pressing on the operating element, wherein the operating element comprises a piezoelectric film mounted on or under a flat spring-like support, which is preferably bent in the unwound state.

DE 103 59 123 A1 discloses an inner lining for a vehicle, especially for a motor vehicle, especially for being arranged on surfaces of the vehicle body, said surfaces being visible in the passenger compartment of the vehicle, wherein the inner lining comprises at least a first pressure pick-up strip for detecting pressure exerted on the first pressure pick-up strip.

### SUMMARY

It is the object of the invention to specify a motor vehicle having an improved operability.

The aforementioned object is attained by a motor vehicle, said motor vehicle comprising a soft fabric arranged in a passenger compartment of the motor vehicle for emitting an output signal depending on pressure exerted on the soft fabric, wherein at least one electrical property of the soft fabric can be changed as a function of the pressure exerted on the soft fabric and wherein the motor vehicle comprises a control unit for evaluating the output signal for the purpose of a text recognition.

An aforementioned electrical property is a capacitance and/or preferably an ohmic resistance. A suitable soft fabric can be obtained, for example, under the name of ElekTex of Eleksen Ltd., Pinewood Studios, Pinewood Road, Iver Heath, Bucks SLO ONH, United Kingdom.

In one design form of the invention, a text of an alphabet-based language, a syllabary-based language and/or a character-based language can recognition. The invention can be used particularly well for inputting text in a character-based language.

In another design form of the invention, the soft fabric is
a part of an inner lining of the passenger compartment of the motor vehicle,
arranged at least on a part of a dashboard of the motor vehicle,
arranged at least on a part of a steering wheel of the motor vehicle,
arranged at least on a part of an inner lining of a door of the motor vehicle,
integrated at least into a part of the inner lining of the door of the motor vehicle,
arranged at least on a part of a center console of the motor vehicle and/or
arranged at least on a part, especially a rear part, of a seat of the motor vehicle.

In another design form of the invention, the soft fabric comprises two conductive layers and also an intermediate layer, which is arranged between the two conductive layers and

which has a considerably lesser conductivity than the other two conductive layers, wherein the conductivity of the intermediate layer can be increased by pressure exerted on the intermediate layer.

The aforementioned object is further attained by a method for operating a motor vehicle comprising especially one or more of the aforementioned features, wherein a soft fabric is arranged in a passenger compartment of the motor vehicle for emitting an output signal depending on a pressure exerted on the soft fabric, and wherein at least one electrical property of the soft fabric can be changed as a function of the pressure exerted on the soft fabric, and wherein the output signal is evaluated for the purpose of a text recognition.

A motor vehicle within the meaning of the invention is especially a land vehicle, which can be used individually in road traffic. Motor vehicles within the meaning of the invention are especially not limited to land vehicles having an internal combustion engine.

Additional advantages and details will become apparent from the following description of example embodiments.

### BRIEF DESCRIPTION OF THE DRAWINGS

FIG. 1 illustrates an example embodiment of a passenger compartment of a motor vehicle;

FIG. 2 is a schematic diagram of the motor vehicle shown in FIG. 1;

FIG. 3 illustrates an example embodiment of a soft fabric for emitting an output signal depending on a pressure exerted on the soft fabric;

FIG. 4 illustrates an example for an input using the soft fabric shown in FIG. 3;

FIG. 5 illustrates an example embodiment of a display arrangement when displaying the oil level;

FIG. 6 illustrates another example for an input using the soft fabric shown in FIG. 3;

FIG. 7 illustrates an example embodiment of a display arrangement when displaying an operating mask for a music system;

FIG. 8 illustrates another example for an input using the soft fabric shown in FIG. 3; and

FIG. 9 illustrates an example embodiment of a display arrangement when displaying an operating mask for an air-conditioner.

### DETAILED DESCRIPTION

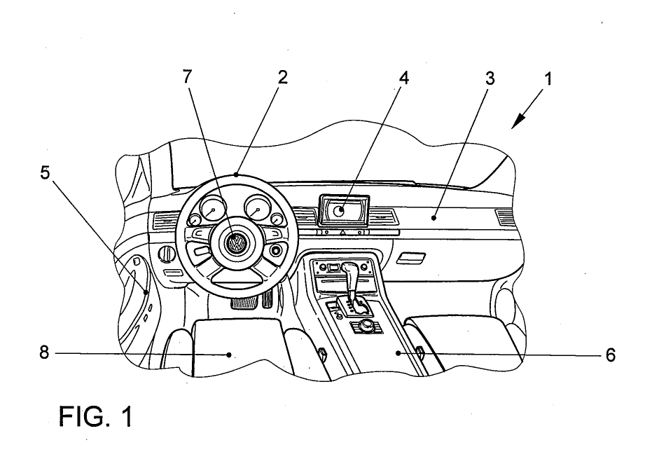

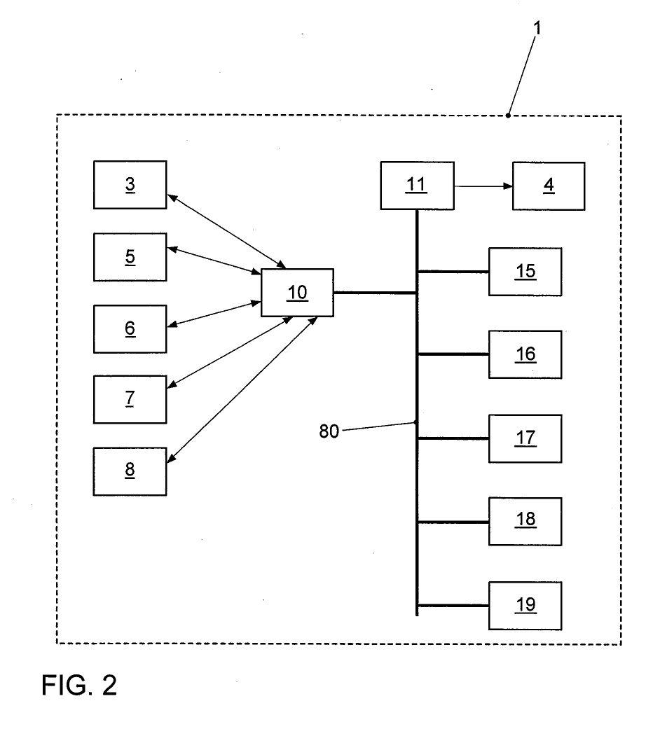

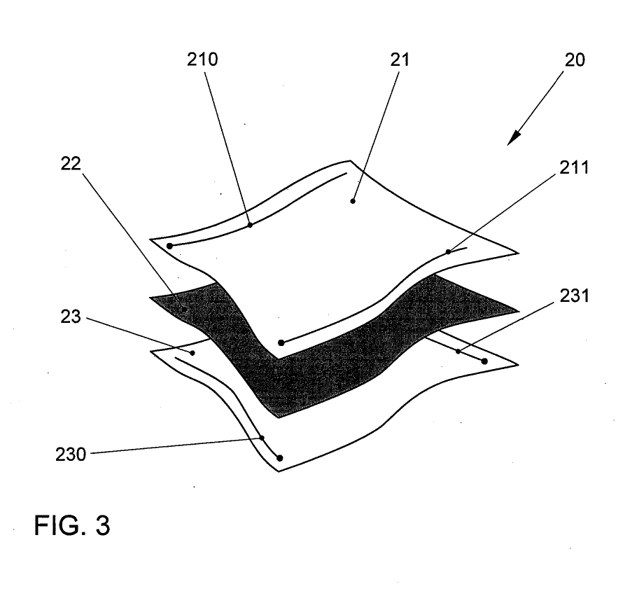

FIG. 1 illustrates an example embodiment of a passenger compartment of a motor vehicle 1 illustrated in FIG. 2 in a schematic diagram. The motor vehicle 1 comprises a soft fabric, which is arranged in its passenger compartment and is described with reference to FIG. 3, for emitting an output signal depending on a pressure exerted on the soft fabric, wherein at least one electrical property of the soft fabric can be changed as a function of the pressure exerted on the soft fabric. Such an electrical property can be a capacitance and/or preferably an ohmic resistance. A suitable soft fabric can be obtained, for example, under the name of ElekTex of Eleksen Ltd., Pinewood Studios, Pinewood Road, Iver Heath, Bucks SLO ONH United Kingdom.

The soft fabric is a part of an inner lining of the passenger compartment. Provision has been made especially for the soft fabric to be arranged at least on a part of a dashboard 3 of the motor vehicle 1, at least on a part of a steering wheel 2 of the motor vehicle 1 or above an airbag 7 arranged in the steering wheel 2, at least on a part of an inner lining of a door 5 of the motor vehicle 1, integrated at least into a part of the inner lining of the door 5 of the motor vehicle 1, arranged at least on a part of a center console 6 of the motor vehicle 1 and/or at least on a part, especially a rear part, of a seat 8 of the motor vehicle 1.

FIG. 3 illustrates the soft fabric in an exploded view. The soft fabric indicated by reference numeral 20 comprises two conductive layers 21 and 23 and also an intermediate layer 22, which is arranged between the two conductive layers 21 and 23 and which has a conductivity, which is considerably less than that of the conductive layers 21 and 23 and which can be increased by pressure exerted on the intermediate layer 22. The conductive layer 21 comprises two conductor tracks 210 and 211, via which a voltage is applied. The conductive layer 23 comprises two conductor tracks 230 and 231. A voltage applied between the conductor tracks 230 and 231 forms the aforementioned output signal.

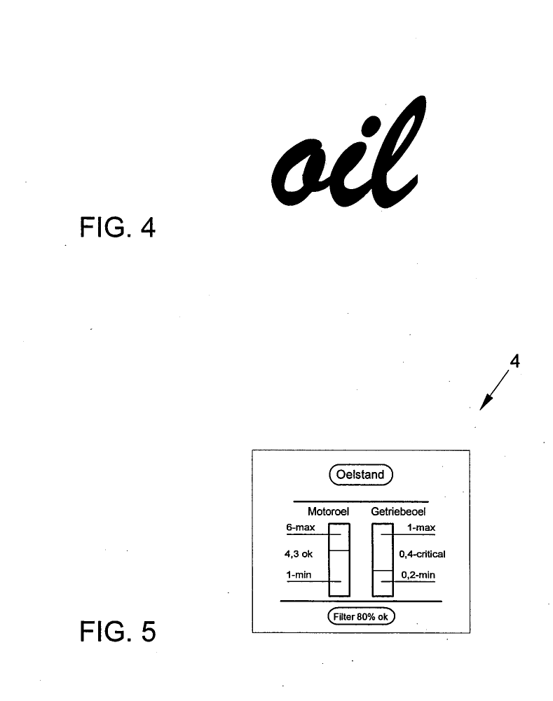

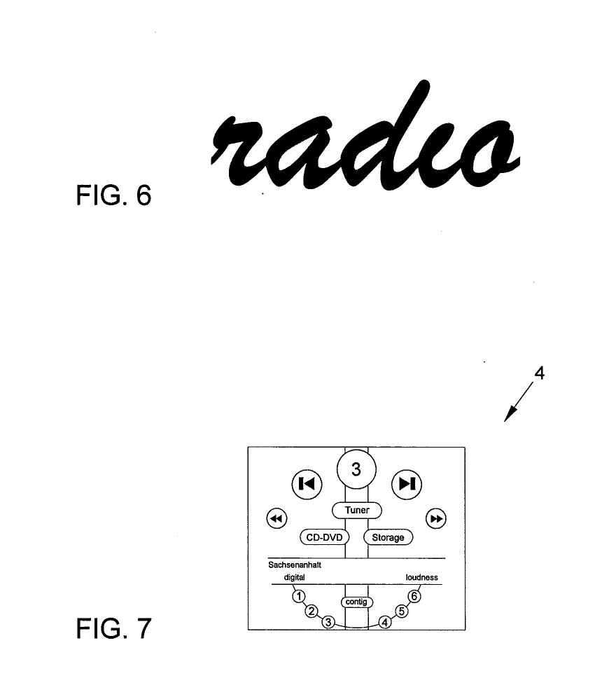

The motor vehicle 1 comprises a control unit 10 illustrated in FIG. 2 for evaluating the output signal. In doing so, the control unit 10 performs a text recognition. If a text is recognized, the control unit 10 determines whether the text corresponds to a valid input or a valid command. The control unit 10 is connected in a manner relevant to data processing technology via a bus system 80 to a display control 11 for controlling a display arrangement 4. Furthermore, a music system 15, a navigation system 16, an air-conditioner 17, a telephone 18 (or a telephone interface) and a motor vehicle control unit 19 are connected to the bus system 80. If a user touches the soft fabric 20 using slight pressure corresponding to the manner illustrated in FIG. 4, the control unit 10 identifies this as the word “oil.” The control unit 10 (or optionally another system of the motor vehicle 1) interprets the input of the word “oil” as a command for displaying the oil level. The oil levels for the engine oil and the gear oil are subsequently transmitted by the motor vehicle control unit 19 to the display control unit 11 and are displayed on the display arrangement 4 by the display control unit 11 using corresponding control as illustrated in FIG. 5. In contrast, if a user touches the soft fabric 20 using slight pressure according to a manner illustrated in FIG. 6, the control unit 10 identifies this as the word “radio.” The control unit 10 (or optionally any other system of the motor vehicle 1) interprets the input of the word “radio” as a command for displaying an operating mask for operating the music system 15.

Provision can be made for interpreting the words “radio,” “CD,” “music,” “tuner,” “news” and “tape” as commands for displaying the operating mask for operating the music system 15. Corresponding to this command, the desired operating mask is displayed on the display arrangement 4 by the display control unit 11 using corresponding control as illustrated in FIG. 7.

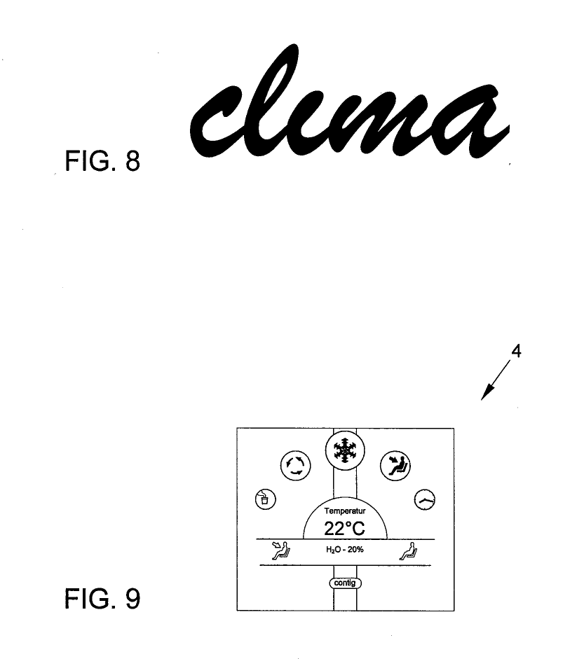

On the other hand, if a user touches the soft fabric 20 under slight pressure corresponding to a manner illustrated in FIG. 8, the control unit 10 identifies it as the word “climate.” The control unit 10 (or optionally any other system of the motor vehicle 1) interprets the input of the word “climate” as a command for displaying an operating mask to operate the air-conditioner 17. Provision can be made to interpret the words “climate,” “cool,” “cold,” “air,” “warm” and “heat” as commands for displaying the operating mask for operating the air-conditioner 17. Corresponding to this command, the desired operating mask is displayed on the display arrangement 4 by the display control 11 using corresponding control as illustrated in FIG. 9.

The navigation system 16 and the telephone 18 can be operated in a corresponding manner by means of the input device comprising the soft fabric 20 and the control unit 10. Place names and personal names or the digits of a telephone number can also be input in a corresponding manner.

A text of an alphabet-based language, a syllabary-based language and/or a character-based language can be recognized by means of a text recognition. The input device described above, comprising the soft fabric 20 and the control unit 10 can be used especially well for inputting text in a character-based language.

### LIST OF REFERENCE NUMERALS

1 Motor vehicle

2 Steering wheel

3 Dashboard

4 Display arrangement

5 Door

6 Center console

7 Airbag

8 Seat

10 Control unit

11 Display control unit

15 Music system

16 Navigation system

17 Air-conditioner

18 Telephone

19 Motor vehicle control unit

20 Soft fabric

21, 23 Conductive layer

22 Intermediate layer

80 Bus system

210, 211, 230, 231 Conductor track

1. A motor vehicle comprising:
a soft fabric arranged in a passenger compartment of the motor vehicle for emitting an output signal depending on pressure exerted on the soft fabric, wherein at least one electrical property of the soft fabric can be changed as a function of the pressure exerted on the soft fabric; and
a control unit for evaluating the output signal for the purpose of a text recognition.

2. A motor vehicle according to claim 1, wherein a text of an alphabet-based language can be recognized by means of text recognition.

3. A motor vehicle according to claim 1, wherein a text of syllabary-based language can be recognized by means of text recognition.

4. A motor vehicle according to claim 1, wherein a text of a character-based language can be recognized by means of text recognition.

5. A motor vehicle according to claim 1, wherein the soft fabric is a part of an inner lining of the passenger compartment.

6. A motor vehicle according to claim 1, said motor vehicle further comprising:
a dashboard, wherein the soft fabric is arranged at least on a part of the dashboard.

7. A motor vehicle according to claim 1, said motor vehicle further comprising:
a steering wheel, wherein the soft fabric is arranged at least on a part of the steering wheel.

8. A motor vehicle according to claim 1, said motor vehicle further comprising:
a door, wherein the soft fabric is arranged at least on a part of an inner lining of the door or is integrated into at least a part of the inner lining of the door.

9. A motor vehicle according to claim 1, said motor vehicle further comprising:
a center console, wherein the soft fabric is arranged at least on a part of the center console.

10. A motor vehicle according to claim 1, said motor vehicle further comprising:
a seat, wherein the soft fabric is arranged at least on a part of the seat.

11. A motor vehicle according to claim 1, the soft fabric comprising:
an intermediate layer, which is arranged between the two conductive layers and which has a considerably lesser conductivity than the other conductive layers, wherein the conductivity of the intermediate layer can be increased by pressure exerted on the intermediate layer.

12. A method for operating a motor vehicle, wherein a soft fabric is arranged in a passenger compartment of the motor vehicle for emitting an output signal depending on pressure exerted on the soft fabric, and wherein at least one electric property of the soft fabric can be changed as a function of the pressure exerted on the soft fabric; said method comprising:
the evaluation of the output signal for the purpose of a text recognition.

13. A motor vehicle comprising:
a soft fabric arranged in a passenger compartment of the motor vehicle for emitting an output signal depending on pressure exerted on the soft fabric, wherein at least one electrical property of the soft fabric can be changed as a function of the pressure exerted on the soft fabric;
a control unit for evaluating the output signal for the purpose of a text recognition, and
an intermediate laver, which is arranged between the two conductive layers and which has a considerably lesser conductivity than the other conductive layers, wherein the conductivity of the intermediate layer can be increased by pressure exerted on the intermediate layer.

14. A motor vehicle according to claim 1, wherein a text of an alphabet-based language or a text of syllabary-based language or a text of a character-based language can be recognized by means of text recognition.

15. A motor vehicle according to claim 1, said motor vehicle further comprising:
a dashboard, wherein the soft fabric is arranged at least on a part of the dashboard.

16. A motor vehicle according to claim 1, said motor vehicle further comprising:
a steering wheel, wherein the soft fabric is arranged at least on a part of the steering wheel.

17. A motor vehicle according to claim 1, said motor vehicle further comprising:
a door, wherein the soft fabric is arranged at least on a part of an inner lining of the door or is integrated into at least a part of the inner lining of the door.

18. A motor vehicle according to claim 1, said motor vehicle further comprising:
a center console, wherein the soft fabric is arranged at least on a part of the center console.

19. A motor vehicle according to claim 1, said motor vehicle further comprising:
a seat, wherein the soft fabric is arranged at least on a part of the seat.

20. A motor vehicle according to claim 1, the soft fabric comprising:
an intermediate layer, which is arranged between the two conductive layers and which has a considerably lesser conductivity than the other conductive layers, wherein the conductivity of the intermediate layer can be increased by pressure exerted on the intermediate layer.
